(19) United States
(12) Patent Application Publication
(10) Pub. No.: US 2012/0086977 A1
(43) Pub. Date: Apr. 12, 2012

(54) PRINTING METHOD, RECORDING MEDIUM, AND INFORMATION PROCESSING APPARATUS

(75) Inventors: Kensuke Hotta, Kawasaki (JP); Mitsuhiro Hayakawa, Kawasaki (JP)

(73) Assignee: FUJITSU LIMITED, Kawasaki-shi (JP)

(21) Appl. No.: 13/252,617

(22) Filed: Oct. 4, 2011

(30) Foreign Application Priority Data
Oct. 6, 2010 (JP) 2010-227010

(51) Int. Cl. G06K 15/02

(52) U.S. Cl. 358/1.15

(57) ABSTRACT

A printing method of print data performed by an apparatus, the method includes, providing a first printing mode in which printing including decoding is performed and a second printing mode in which printing without decoding is performed to an output apparatus as options, generating code information by decoding coded information included in the print data when the first printing mode is selected, storing the code information into a storage device, generating a synthesized image based on the code information and the print data, and deleting the code information in the storage device after printing the synthesized image.

### CROSS-REFERENCE TO RELATED APPLICATIONS

This application is based upon and claims the benefit of priority of the prior Japanese Patent Application No. 2010-227010, filed on Oct. 6, 2010, the entire contents of which are incorporated herein by reference.

### FIELD

The present embodiment relates to a printing method and a recording medium of print data including coded information such as one-dimensional code and two-dimensional code.

### BACKGROUND

Coded information in which various information is coded is widely used. In recent years, one-dimensional code and two-dimensional code are commonly used as the coded information. The one-dimensional code is a combination of white bars and black bars, and for example, used as an identification code. An example of the one-dimensional code is a barcode. The two-dimensional code is a code having meanings in both vertical and horizontal directions. An example of the two-dimensional code is a QR (Quick Response) code.

Conventionally, regarding processing of the two-dimensional code such as the QR code, a prior art is known in which character information converted from a two-dimensional code having a predetermined format detected from image data is associated with a part of the image data.

Regarding processing of a document including a two-dimensional code, a prior art is known which generates image data in which a QR code extracted from an original image data read from the document is arranged at a specified position.

Regarding printing processing of the two-dimensional code or the like, a prior art is known in which a one-dimensional code or a two-dimensional code converted from a set destination code is printed along with a destination name.

Regarding a printing program for adding a one-dimensional code or a two-dimensional code to a document, a prior art is known in which an image of a code generated according to a character string and print data are synthesized together.

If a one-dimensional code or a two-dimensional code is included in print data, it is possible to print the one-dimensional code or the two-dimensional code along with the print data.

When printing original data (character information) of a one-dimensional code or a two-dimensional code, the one-dimensional code or the two-dimensional code is decoded and the character information is converted into an image. The processing of decoding and conversion into an image is performed by a processing apparatus such as a personal computer (PC), and the character information is easily recognized.

Generally, one-dimensional code or two-dimensional code has a security function. However, decoding and conversion into an image, and the character information obtained by printing the image become a cause to degrade such a security function.

### SUMMARY

According to an aspect of the invention, a printing method of print data performed by an apparatus, the method includes, providing a first printing mode in which printing including decoding is performed and a second printing mode in which printing without decoding is performed to an output apparatus as options, generating code information by decoding coded information included in the print data when the first printing mode is selected, storing the code information into a storage device, generating a synthesized image based on the code information and the print data, and deleting the code information in the storage device after printing the synthesized image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a flowchart illustrating an example of printing processing according to a first embodiment.

FIG. 2 is a diagram illustrating an example of a printer driver.

FIG. 3 is a diagram illustrating an example of a printing system according to a second embodiment.

FIG. 4 is a diagram illustrating an example of a personal computer connected to a printer.

FIG. 5 is a diagram illustrating an example of a storage device.

FIG. 6 is a diagram illustrating an example of the printer driver.

FIG. 7 is a diagram illustrating an example of a print information specification of the printer driver.

FIG. 8 is a diagram illustrating an example of acquisition processing of two-dimensional code print information in the printer driver.

FIG. 9 is a diagram illustrating an example of a printing setting screen.

FIG. 10 is a diagram illustrating an example of a detail setting screen of two-dimensional code.

FIG. 11 is a diagram illustrating an example of a QR code printing setting screen.

FIG. 12 is a diagram illustrating an example of a file selection screen.

FIG. 13 is a flowchart illustrating an example of an operation procedure of the printing system.

FIG. 14 is a diagram illustrating an example of an image synthesis function by the printer driver.

FIG. 15 is a diagram illustrating an example of image synthesis processing.

FIG. 16 is a flowchart illustrating an example of a processing procedure of printing.

FIG. 17 is a diagram illustrating an example of image synthesis processing.

FIG. 18 is a flowchart illustrating an example of another image synthesis processing.

FIG. 19 is a diagram illustrating an example of image synthesis processing of the printer driver.

FIG. 20 is a diagram illustrating an example of printer queue setting according to a third embodiment.

FIG. 21 is a diagram illustrating an example of a storage device according to a fourth embodiment.

FIG. 22 is a diagram illustrating an example of a printer driver according to a fourth embodiment.

FIG. 23 is a diagram illustrating an example of a printer according to a fifth embodiment.

FIG. 24 is a diagram illustrating a printing system using a mobile terminal apparatus.

FIG. 25 is a diagram illustrating a printing system using a digital camera.

### DESCRIPTION OF EMBODIMENTS

### First Embodiment

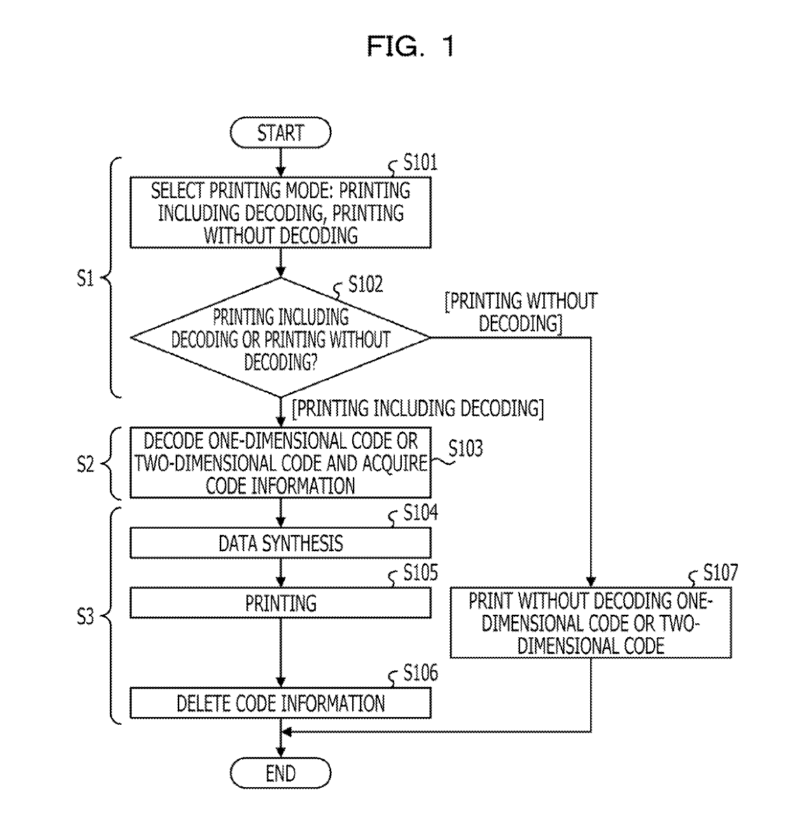

A first embodiment will be described with reference to FIG. 1. FIG. 1 illustrates an example of a processing procedure of printing processing according to the first embodiment.

The processing procedure is an example of a processing procedure of a printing method disclosed in this description or a program implementing the printing method. As illustrated in FIG. 1, the processing procedure is a processing procedure of print data including coded information and includes selection of printing mode (Operation S1), acquisition of code information (Operation S2), and processing of print data (Operation S3). An example of the coded information is one-dimensional code and two-dimensional code. The one-dimensional code is a combination of white bars and black bars, and is, for example, a barcode. The two-dimensional code is a code with a format having information in both vertical and horizontal directions. The two-dimensional code includes more information than the one-dimensional code and the print area thereof is small. As the two-dimensional code, a matrix type code in which small squares are arranged vertically and horizontally and a stack type code in which a plurality of one-dimensional codes are stacked vertically are known. An example of the two-dimensional code is the QR (Quick Response) code mentioned above, a Maxi code, a Veri code, and PDF417. Hereinafter, embodiments which use one-dimensional code and two-dimensional code widely used in the world will be described. However the embodiments are not limited to these coded information.

First, the selection of printing mode (Operation S1) causes a user to select a printing mode from printing modes which include at least printing including decoding (first printing mode) and printing without decoding (second printing mode) as options (Operation S101). Decoding is to convert one-dimensional code or two-dimensional code included in print data into original information, that is, to return encrypted data back to its original format. The original information is “code information” of the one-dimensional code or the two-dimensional code. Character information is an example of the code information.

Next, it is determined whether the printing including decoding or the printing without decoding is selected (Operation S102). If the printing including decoding is selected, one-dimensional code or two-dimensional code included in the print data is decoded and code information is acquired (Operation S103).

The processing of print data (Operation S3) generates a synthesized image including code information and an image of the print data by data synthesis (Operation S104). Then, the processing of print data prints the synthesized image (Operation S105), and thereafter, deletes the code information (Operation S106).

If the printing without decoding is selected in Operation S102, the print data including the one-dimensional code or the two-dimensional code is printed without decoding the one-dimensional code or the two-dimensional code (Operation S107).

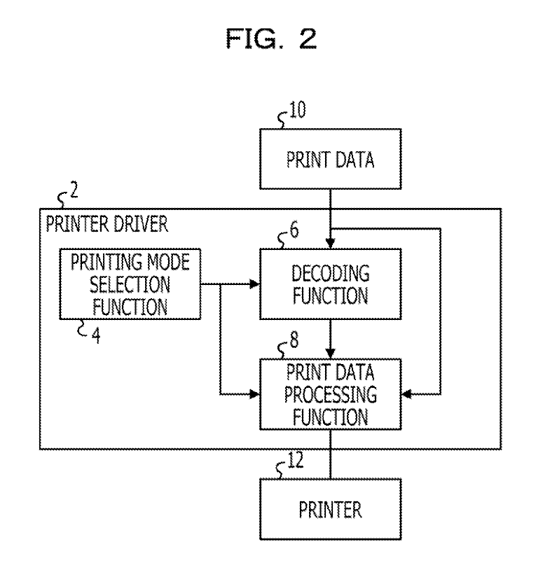

Next, a program implementing the processing procedure will be described with reference to FIG. 2. FIG. 2 illustrates an example of a printer driver.

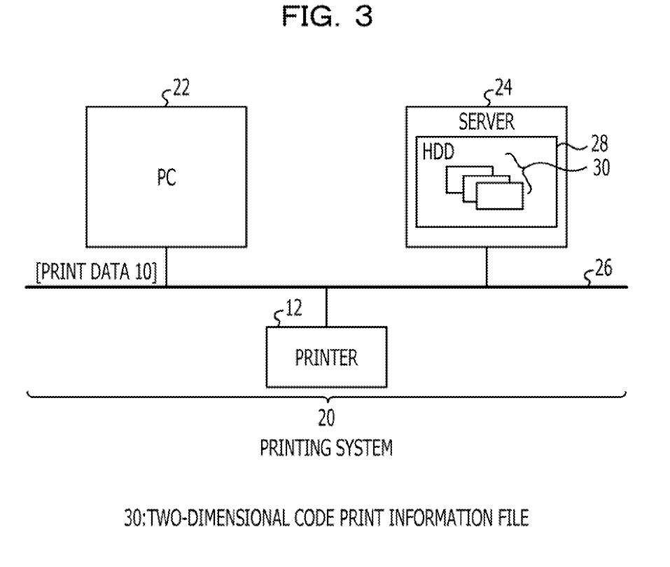

The printer driver 2 is an example of the program disclosed in this description. The printer driver 2 is a program for implementing the printing method described above (FIG. 1) by a computer or an information processing apparatus including a computer (for example, PC 22: FIG. 3). This program includes processes of decoding one-dimensional code or two-dimensional code from the print data and forming a synthesized image as described above in addition to basic processes such as input/output of a printer 12. As illustrated in FIG. 2, the printer drive 2 includes a printing mode selection function 4, a decoding function 6, and a print data processing function 8.

The printing mode selection function 4 is a function for providing printing modes including at least the printing including decoding (first printing mode) and the printing without decoding (second printing mode) as options for printing print data 10 and causing a user to select one of the printings. As described above, the printing including encoding is to decode the one-dimensional code or the two-dimensional code included in the print data 10 and cause the printer 12 to print the print data 10 including the code information obtained by the decoding. As described above, the printing without encoding is to cause the printer 12 to print the print data 10 without decoding the one-dimensional code or the two-dimensional code included in the print data 10.

The decoding function 6 is a function for decoding the one-dimensional code or the two-dimensional code included in the print data 10 to obtain code information. The code information is original data of the one-dimensional code or the two-dimensional code.

The print data processing function 8 is a function for processing print data and includes the printing including decoding and the printing without decoding. The printing including decoding generates a synthesized image including code information and an image of the print data 10 by data synthesis. After printing the synthesized image, the printing including decoding deletes the code information. The printing without decoding prints an image of the print data including the one-dimensional code or the two-dimensional code which are not decoded. In the printing without decoding, the one-dimensional code or the two-dimensional code are not decoded, so they are not deleted.

Since the printer driver 2 has such functions, the printing method described above is implemented and the embodiment exerts the following effects.

(1) Options include at least the printing including decoding and the printing without decoding. Therefore, a desired printing mode may be selected from the options before printing. Thus, convenience of printing related to print data including one-dimensional code or two-dimensional code is improved.

(2) Since the code information is deleted after the printing of print data including decoding, the code information does not remain in the processing apparatus. Thereby the security function of the printing with decoding may be improved.

### Second Embodiment

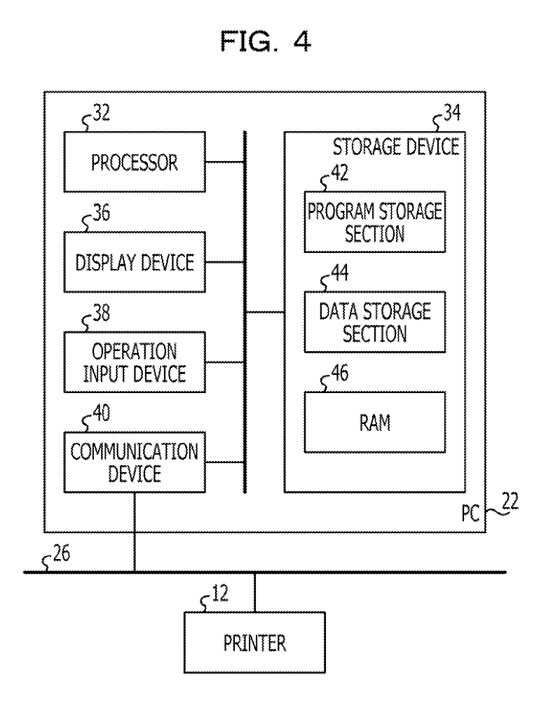

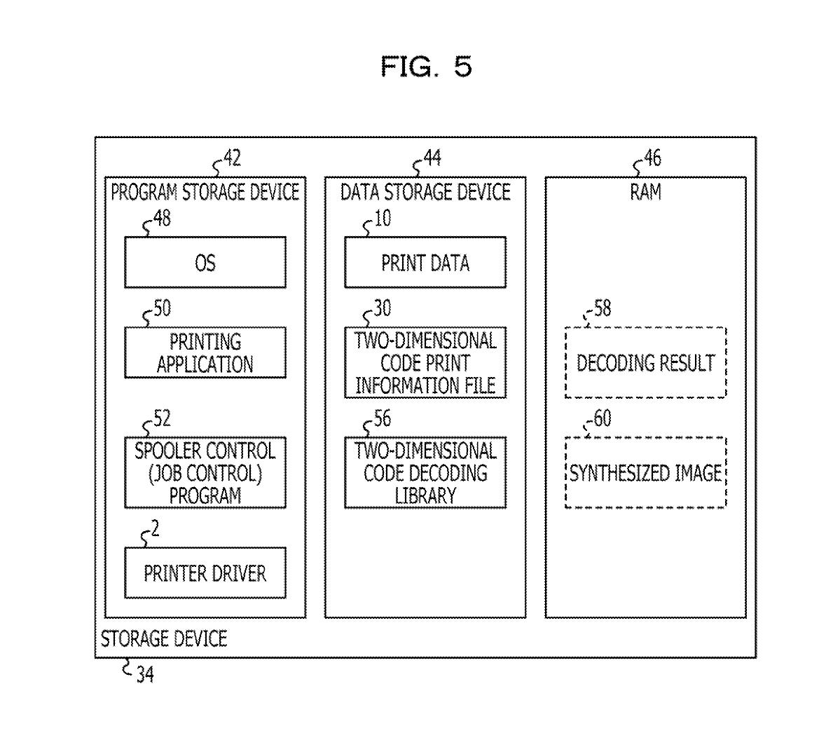

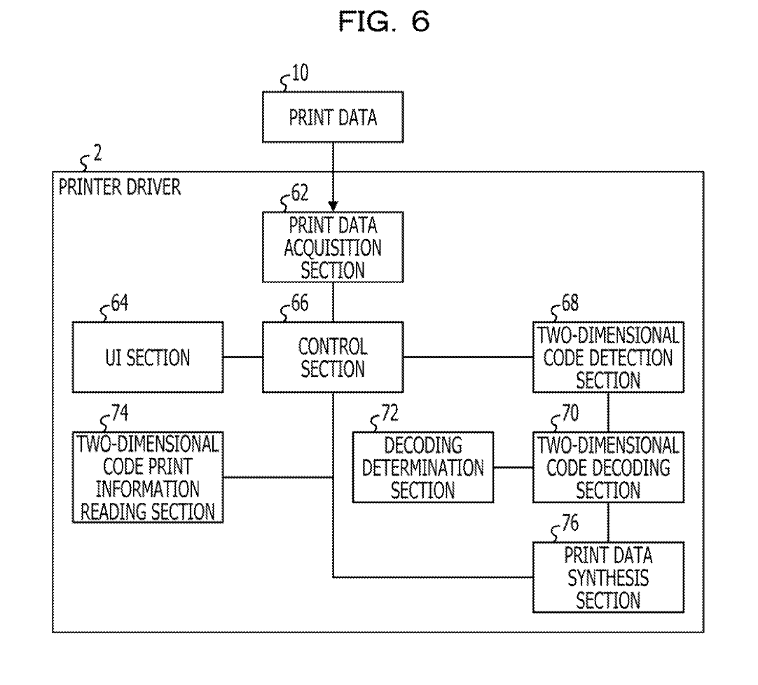

A second embodiment will be described with reference to FIGS. 3, 4, 5, and 6. FIG. 3 illustrates an example of a printing system. FIG. 4 illustrates an example of a PC. FIG. 5 illustrates an example of a storage device. FIG. 6 illustrates an example of a printer driver. In FIGS. 3, 4, 5, and 6, the same portions as those in FIG. 2 are given the same reference numerals. Hereinafter, as an example of coded information, an embodiment using two-dimensional code will be described, however, the coded information may be other information such as one-dimensional code in the embodiment.

The printing system 20 is an example of a printing apparatus disclosed in this description. As illustrated in FIG. 3, the printing system 20 includes a personal computer (PC) 22, a server 24, and a printer 12, which are connected to each other via the cable 26.

The PC 22 is an example of the information processing apparatus disclosed in this description and processes print data including a two-dimensional code. The printer driver 2 for causing the printer 12 to perform printing is installed in the PC 22.

The server 24 is an example of an information source. In the present embodiment, the server 24 has a hard disk apparatus (HDD) 28. A two-dimensional code print information file 30 is stored in the HDD 28. The two-dimensional code print information file 30 is a file in which arrangement positions of two-dimensional code and the like are defined. If the two-dimensional code print information file 30 is included in the PC 22, the two-dimensional code print information file 30 may not be included in the server 24.

The printer 12 is an example of a printing means for printing print data outputted from the PC 22.

The cable 26 is a connection means, and, for example, is a USB (Universal Serial Bus) cable, a LAN (Local Area Network) cable, or the like.

The PC 22 is a means for executing the printer driver 2 described above. As illustrated in FIG. 4, the PC 22 includes a processor 32, a storage device 34, a display device 36, an operation input device 38, and a communication device 40.

The processor 32 is an example of a control means for executing an OS (Operating System) and the printer driver 2 in the storage device 34.

The storage device 34 is an example of a means for storing the OS, programs, and data. The storage device 34 includes a program storage section 42, a data storage section 44, and a RAM (Random-Access Memory) 46. The program storage section 42 stores the OS, the printer driver 2, and the like, and the data storage section 44 stores data. The program storage section 42 and the data storage section 44 are an example of a recording medium that may be read by a computer. For example, such a medium is a hard disk apparatus (HDD), but may be a portable recording medium such as a CD-ROM, a DVD disk, and a USB memory, or a semiconductor memory such as a flash memory. The RAM 46 provides a work area in which the printer driver 2 is loaded.

The display device 36 is an example of an information display means which is controlled by the processor 32 and on which information such as input information and control information is displayed. The display device 36 is, for example, an LCD (Liquid Crystal Display) display device.

The operation input device 38 is an example of an input means which is controlled by the processor 32 and on which information selection and information input are performed by an operation. The operation input device 38 is, for example, a keyboard, a mouse, a touch sensor disposed on a display screen of the display device 36, and the like.

The communication device 40 is an example of a communication means for communicating with external devices such as the printer 12. The communication device 40 is provided with an input/output port and connected to the printer 12 via the cable 26.

As illustrated in FIG. 5, the program storage section 42 stores programs such as an OS 48, a printing application 50, a spooler control (job control) program 52, and the printer driver 2. The OS 48 is an OS program such as, for example, Windows (registered trademark) or UNIX (registered trademark).

The printing application 50 is a program such as, for example, WORD (registered trademark) and Excel (registered trademark). The printing application 50 issues a print request. The print request includes normal print data 10 and a two-dimensional code. The two-dimensional code is data including a print ID and characters.

The spooler control (job control) program 52 is a program for temporarily storing printing processing requests (jobs) generated at the same time in the data storage section 44 and sequentially causing the printer 12 to execute the printing processing requests.

The printer driver 2 is a program for controlling various processing including basic processing such as input/output of the printer 12. The printer driver 2 includes functions such as selecting and specifying whether or not to decode two-dimensional code, specifying the font and size of decoded characters, and selecting the arrangement position of the decoded characters.

The data storage section 44 stores data such as the two-dimensional code print information file 30 (FIG. 3) described above, a two-dimensional code decoding library 56, and the print data 10.

The RAM 46 provides a work area and the printer driver 2 describe above is loaded into the work area. A decoding result 58 and a synthesized image 60 are stored in the work area of the RAM 46 during printing processing of the printer driver 2. After the printing, the decoding result 58 and the synthesized image 60 are deleted from the work area.

The printer driver 2 includes a print data acquisition function, a UI setting function, a control function, a two-dimensional code detection function, a two-dimensional code decoding function, a decoding determination function, a two-dimensional code print information reading function, a print data synthesis function. As illustrated in FIG. 6, these functions are implemented by functional units of the printer driver 2.

A print data acquisition section 62 is an example of a function (means) for acquiring the print data 10 and print image from the processor 32 or the storage device 34.

A UI section 64 is an example of a user setting function. The UI section 64 is a function for receiving a specification of a file name of a decoded file of two-dimensional code and a setting of whether or not to decode two-dimensional code from a user.

A control section 66 is a function (means) for performing generation processing of a print image from the print data 10 or the like according to a user's specification set in the UI section 64.

A two-dimensional code detection section 68 is a function for detecting a two-dimensional code from the print data 10.

A two-dimensional code decoding section 70 is a function for decoding a two-dimensional code into code information (original data of the two-dimensional code).

A decoding determination section 72 is a function for receiving the specification of UI section 64 and determining whether or not to decode two-dimensional code.

A two-dimensional code print information reading section 74 is an example of a function for reading a setting file. The two-dimensional code print information reading section 74 is a function for reading the two-dimensional code print information file 30 set by a user.

A print data synthesis section 76 is a function for generating a synthesized image (data) in which code information (code content) obtained by decoding a two-dimensional code is synthesized with the print data 10 in a size and print position specified by the two-dimensional code print information file 30.

In the printing system 20 including the printer driver 2 described above, the printing application 50 issues a print request. The print data 10 includes, for example, normal print data and a two-dimensional code. The two-dimensional code is data including a print ID and characters.

The printer driver 2 detects and decodes a two-dimensional code according to content specified by the UI section 64. Also, the printer driver 2 acquires (reads) an arrangement position of the two-dimensional code from the two-dimensional code print information file 30. The printer driver 2 synthesizes normal data and decoded data together. At this time, the decoded data is synthesized to be outputted at the arrangement position acquired from the file. The printer driver 2 outputs the synthesized data to the printer 12 and requests the printer 12 to print the synthesized data.

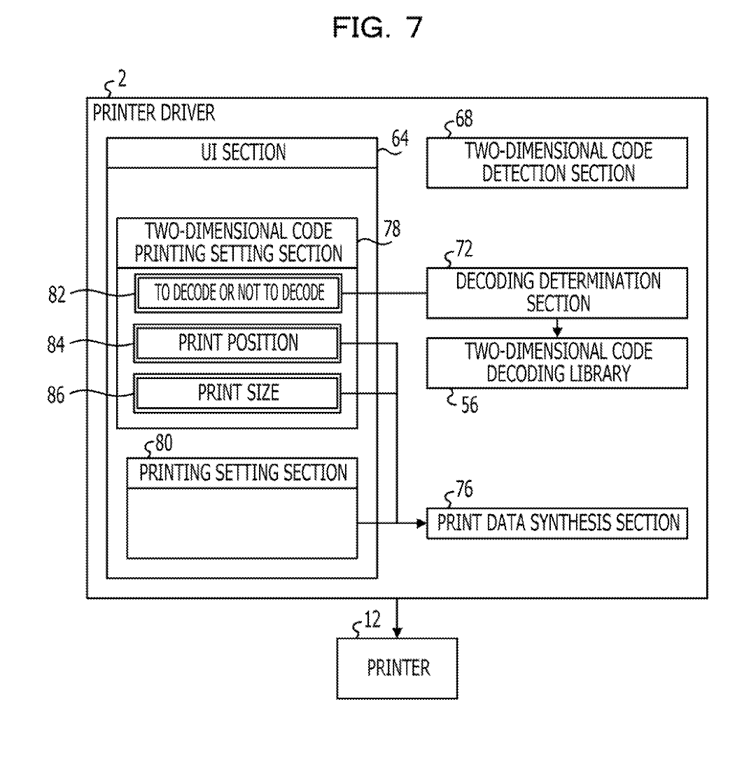

Next, the specification of the two-dimensional code print information will be described with reference to FIG. 7. FIG. 7 illustrates an example of the specification of the two-dimensional code print information. In FIG. 7, the same portions as those in FIGS. 5 and 6 are given the same reference numerals.

As illustrated in FIG. 7, the UI section 64 of the printer driver 2 includes a two-dimensional code printing setting section 78 and a printing setting section 80. The two-dimensional code detection section 68 detects a two-dimensional code included in the print data 10. When the two-dimensional code detection section 68 detects that a two-dimensional code is included in the print data 10, the two-dimensional code printing setting section 78 and the printing setting section 80 are activated.

The two-dimensional code printing setting section 78 includes a decoding specification 82, a print position specification 84, and a print size specification 86. The decoding specification 82 specifies whether to decode or not to decode according to user's selection. A decoding determination section 72 receives the decoding specification 82 and determines whether to decode or not to decode.

The print position specification 84 specifies a print position of the code information obtained by the decoding. The print size specification 86 specifies a print size of the code information. The printing setting section 80 issues a printing instruction. The print data synthesis section 76 receives these specifications and the printing instruction and synthesizes the code information decoded from the two-dimensional code and the print data 10 together to generate synthesized data.

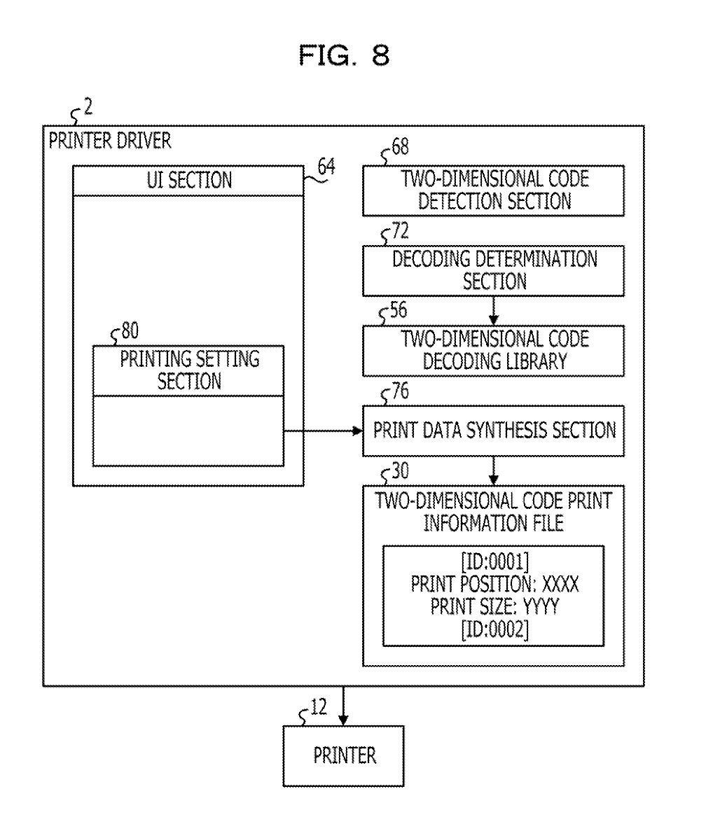

Next, acquisition of the two-dimensional code print information will be described with reference to FIG. 8. FIG. 8 illustrates an example of acquisition processing of the two-dimensional code print information. In FIG. 8, the same portions as those in FIGS. 5, 6, and 7 are given the same reference numerals.

The printer driver 2 acquires the two-dimensional code print information from a print information ID specified for the two-dimensional code. As illustrated in FIG. 8, this processing is performed by the print data synthesis section 76 and the two-dimensional code print information file 30 on the basis of the printing instruction from the printing setting section 80 of the UI section 64.

In this example, an ID (0001) is acquired from the two-dimensional code and a print position: XXXX and a print size: YYYY are acquired from the two-dimensional code print information file 30.

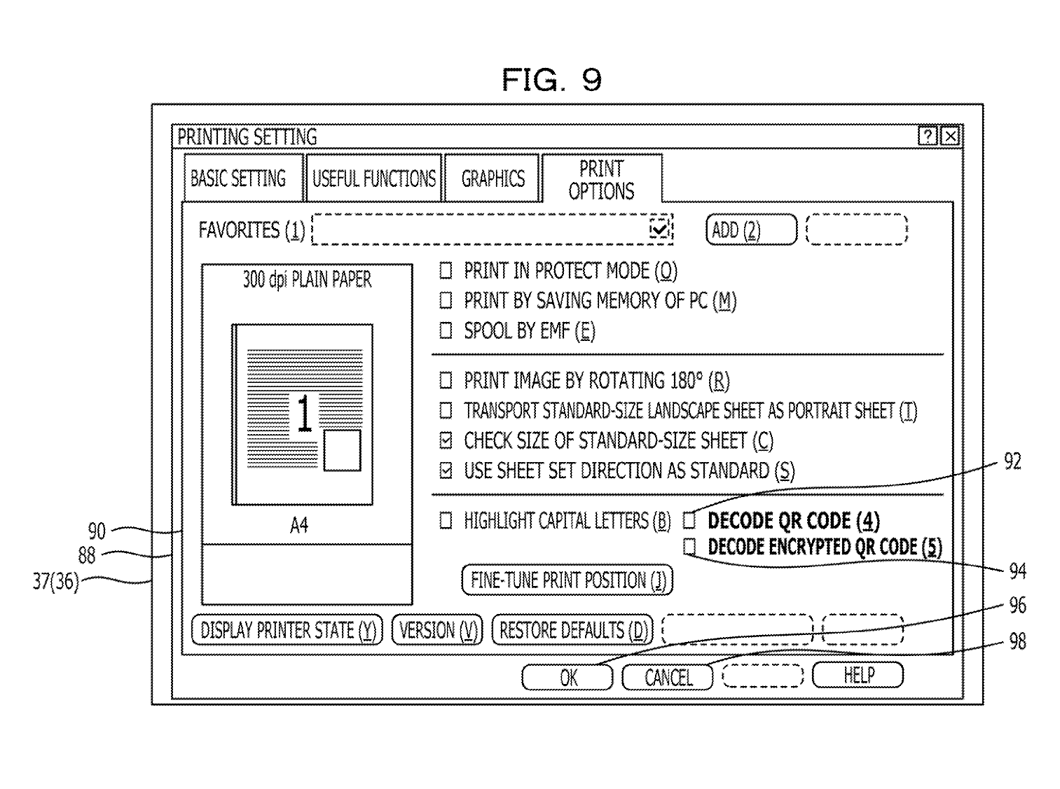

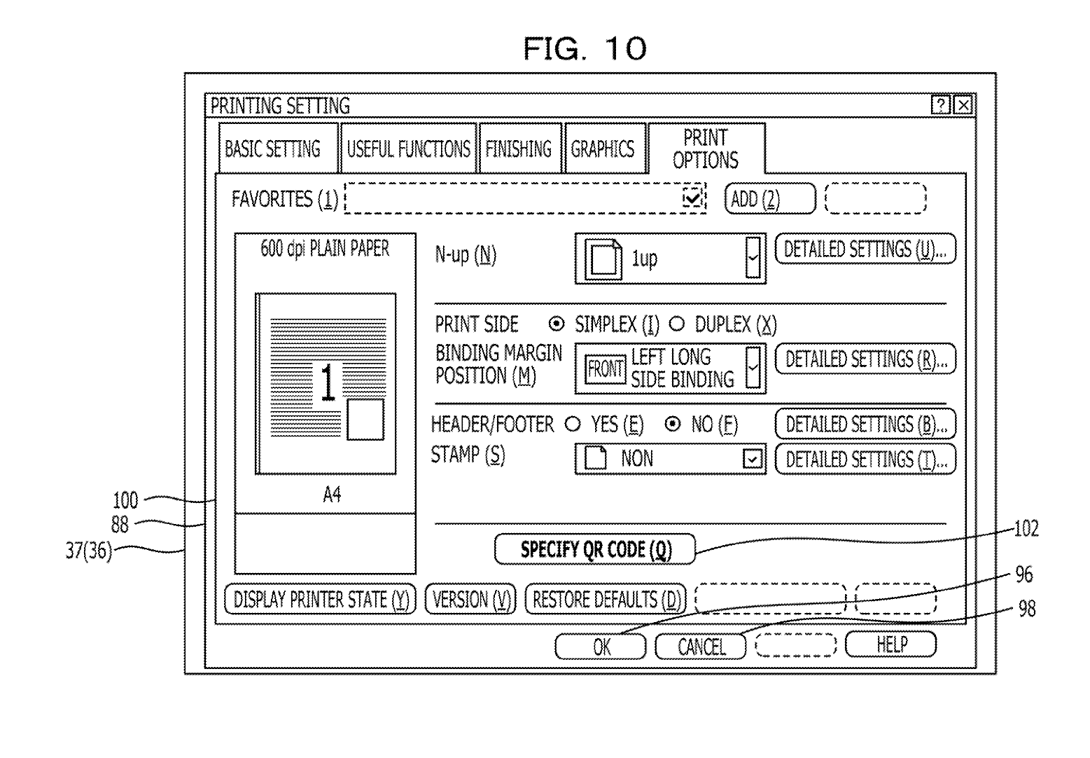

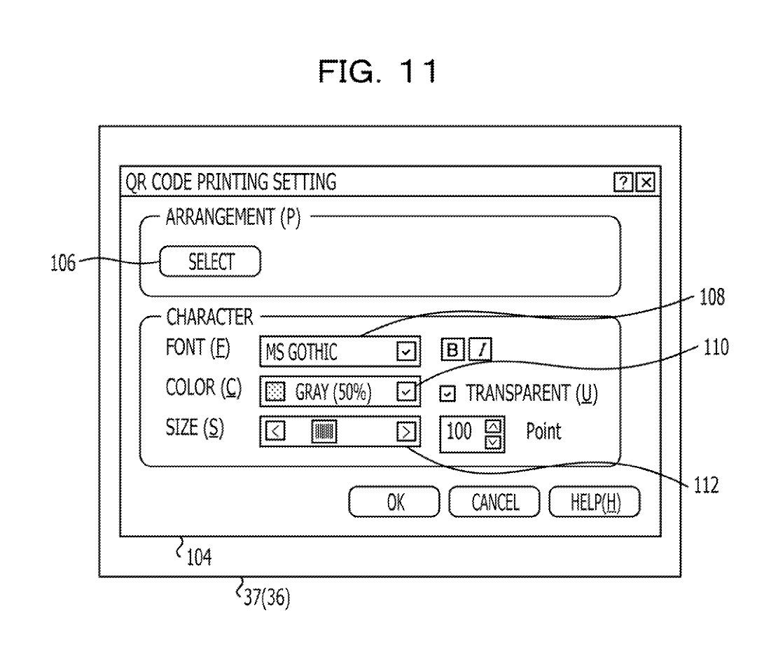

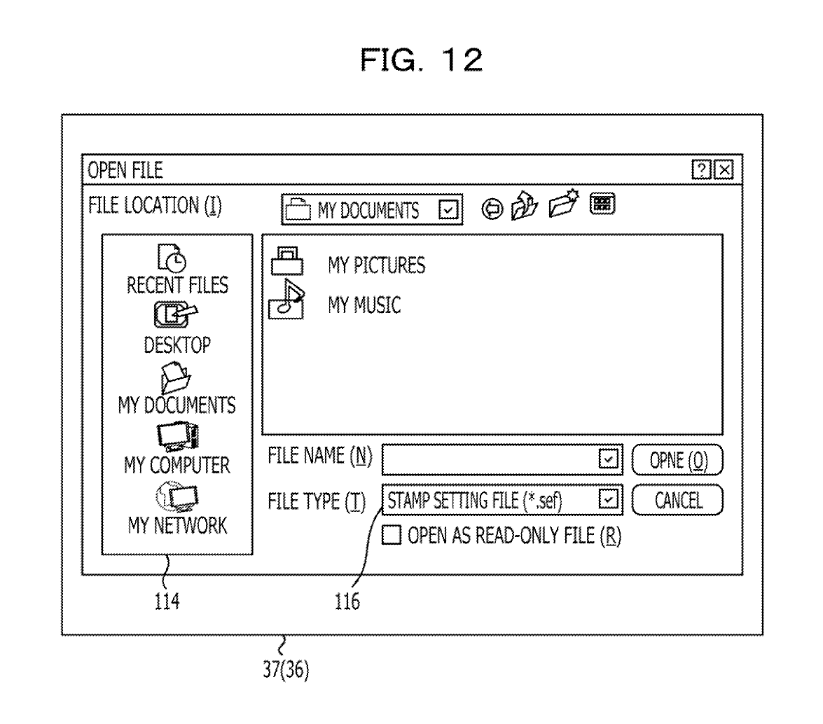

Next, a screen setting will be described with reference to FIGS. 9, 10, 11, and 12. FIG. 9 illustrates an example of a printing setting screen. FIG. 10 illustrates an example of a detail setting screen of two-dimensional code. FIG. 11 illustrates a printing setting screen of QR code. FIG. 12 illustrates an example of a file selection screen. In FIGS. 9, 10, 11, and 12, the same portions as those in FIG. 4 are given the same reference numerals.

A printing setting screen 88 is displayed on a display screen 37 of the display device 36 (FIG. 4). The printing setting screen 88 is an example of a functional screen of the printing setting. In the printing setting screen 88, a printing option tab screen 90 set in the printer property is displayed. In the printing setting screen 88, a first decoding specification checkbox 92 and a second decoding specification checkbox 94 are set. The decoding specification checkbox 92 is a checkbox for selecting whether to decode or not to decode QR code, which is a two-dimensional code, and a function specification “decode QR code” is clearly expressed for the decoding specification checkbox 92. The decoding specification checkbox 94 is a checkbox for selecting whether to decode or not to decode encrypted QR code, and a function specification “decode encrypted QR code” is clearly expressed for the decoding specification checkbox 94. In this case, the QR code is an example of a two-dimensional code as described above.

In the printing setting screen 88, an OK button 96 is set as an instruction button for determining instruction information, and a cancel button 98 for cancelling instruction information is set. Therefore, to determine specification of the decoding specification checkboxes 92 and 94, a cursor is pointed on the OK button 96 and an enter key on the operation input device 38 is pressed or an input determination operation of the mouse is performed.

In the printing setting screen 88 of the printer property, as another tab screen, a useful functions tab screen 100 is set as illustrated in FIG. 10. In the useful functions tab screen 100, a QR code specification button 102 is set. When pointing the cursor on the QR code specification button 102 and pressing the enter key or performing the input determination operation of the mouse, a QR code (two-dimensional code) printing setting screen 104 (FIG. 11) is opened.

The printing setting screen 104 is an input screen for specifying print information for printing a QR code. In the printing setting screen 104, as illustrated in FIG. 11, a character font specification box 108, a color specification box 110, and a size specification box 112 are set along with a select button 106. The select button 106 is an input button for selecting a QR code setting file. As described below, an arrangement position may be specified by the QR code setting file.

The character font specification box 108, the color specification box 110, and the size specification box 112 are an input means (user interface) for specifying a character font and the like when printing character information of the QR code. The character font specification box 108 is a means for specifying a font of characters. In FIG. 11, as a font of characters, for example, MS Gothic is specified. The color specification box 110 is a means for specifying a printing color of characters. In FIG. 11, as a printing color of characters, for example, gray (50%) is specified. The size specification box 112 is a means for specifying the character size. In the display screen illustrated in FIG. 11, for example, 100 is specified as a point. These settings are specification information for the printer driver 2. These settings are set in the printer driver 2 and need not be set for each job.

When pressing the select button 106 (FIG. 11) on the QR code printing setting screen 104, as illustrated in FIG. 12, a file selection screen 114 for selecting a setting file indicating an arrangement position is illustrated. The file selection screen 114 is an input screen for selecting and specifying a setting file indicating an arrangement position of the code information. In the file selection screen 114, an input box 116 for inputting a type of the file is set. It is possible to input a setting file in the input box 116 or select a type of the setting file from the input box 116. In this example, “stamp setting file” is selected.

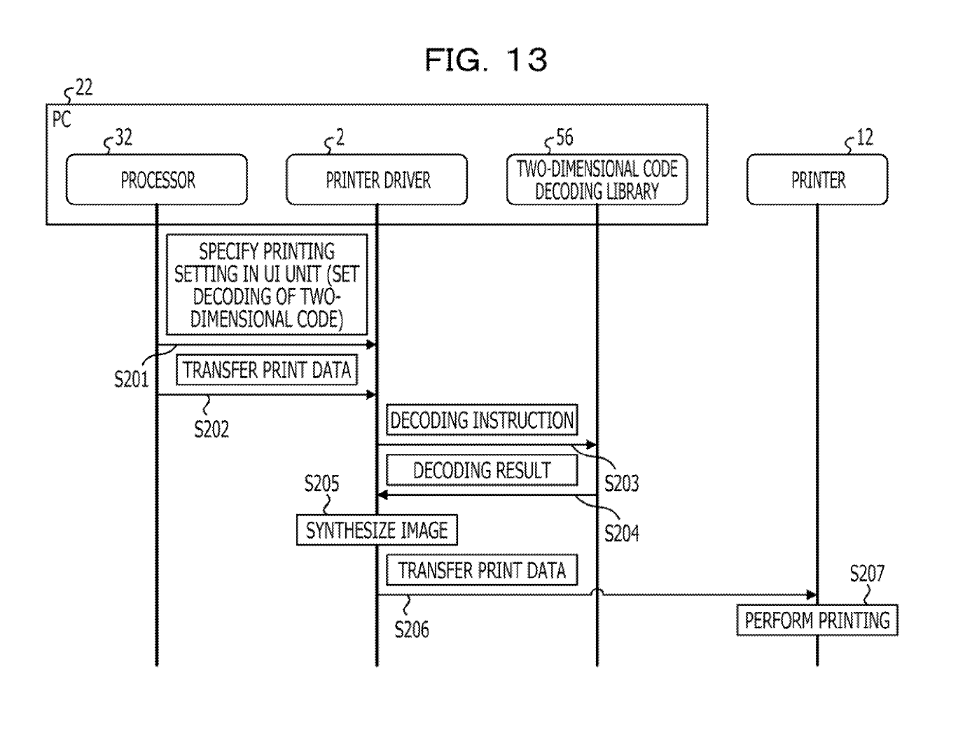

Next, a printing operation of the printing system 20 will be described with reference to FIG. 13. FIG. 13 illustrates an example of a processing sequence of the printing system.

The processing sequence is an example of the printing method disclosed in this description. In the processing sequence, the processes of the processor 32 of the PC 22, the printer driver 2, the two-dimensional code decoding library 56, and the printer 12 are illustrated in association with each other.

In the processing sequence, as illustrated in FIG. 13, the printing setting is performed in the UI section 64 of the printer driver 2 (Operation S201). For example, decoding of two-dimensional code is set. When the decoding of two-dimensional code and the two-dimensional code print information file 30 are specified in the UI section 64 and printing is instructed, print data is transferred from the processor 32 to the printer driver 2 (Operation S202). The printer driver 2 instructs the two-dimensional code decoding library 56 to decode two-dimensional code in the print data 10 (Operation S203). The two-dimensional code decoding library 56 provides data of the decoded two-dimensional code to the printer driver 2 (Operation S204).

The printer driver 2 synthesizes the decoding result and the original print data 10 together to generate synthesized print data (Operation S205). The printer driver 2 transmits the generated synthesized print data to the printer 12 (Operation S206). The printer 12 prints the transferred synthesized print data (Operation S207). In this case, if two-dimensional code is not included in the print data 10, the synthesized print data is the same as the print data 10 which is the original data.

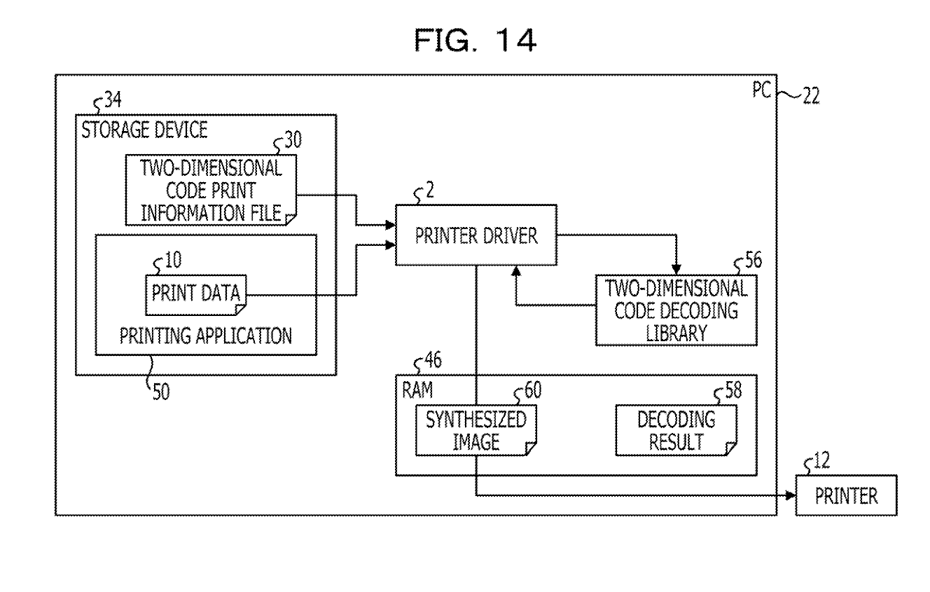

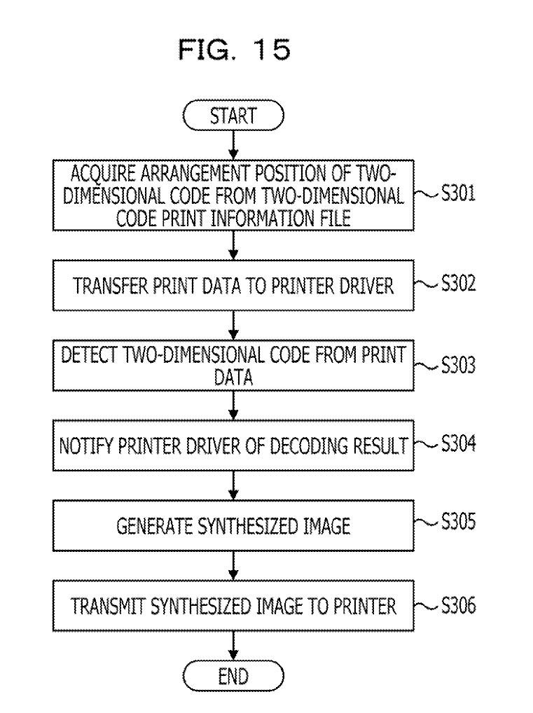

Next, processing procedure of data synthesis will be described with reference to FIGS. 14 and 15. FIG. 14 illustrates an example of the processing procedure of data synthesis. FIG. 15 illustrates a flowchart of the processing procedure of data synthesis.

The data synthesis is an example of image synthesis processing. The data storage section 44 stores the print data 10 and the two-dimensional code print information file 30. In the data synthesis processing, the printer driver 2 acquires (reads) an arrangement position of two-dimensional code (Operation S301). The print data 10 from the printing application 50 is transferred to the printer driver 2 (Operation S302). The printer driver 2 which receives the print data 10 instructs the two-dimensional code decoding library 56 to detect two-dimensional code from the print data 10 and decode the two-dimensional code (Operation S303). The two-dimensional code decoding library 56 decodes the two-dimensional code, generates a decoding result 58 on the RAM 46, and notifies the printer driver 2 of the decoding result 58 (Operation S304). The printer driver 2 synthesizes the decoding result 58 and the print data 10 together to generate a synthesized image 60 (Operation S305). The synthesized image 60 is transmitted to the printer 12 and the printer 12 prints the synthesized image 60 (Operation S306). In this case, if there is not the decoding result 58, only the print data 10 is printed.

After the printing is completed, the synthesized image 60 and the decoding result 58 on the RAM 46 are deleted from the RAM 46 and they don't remain in the PC 22.

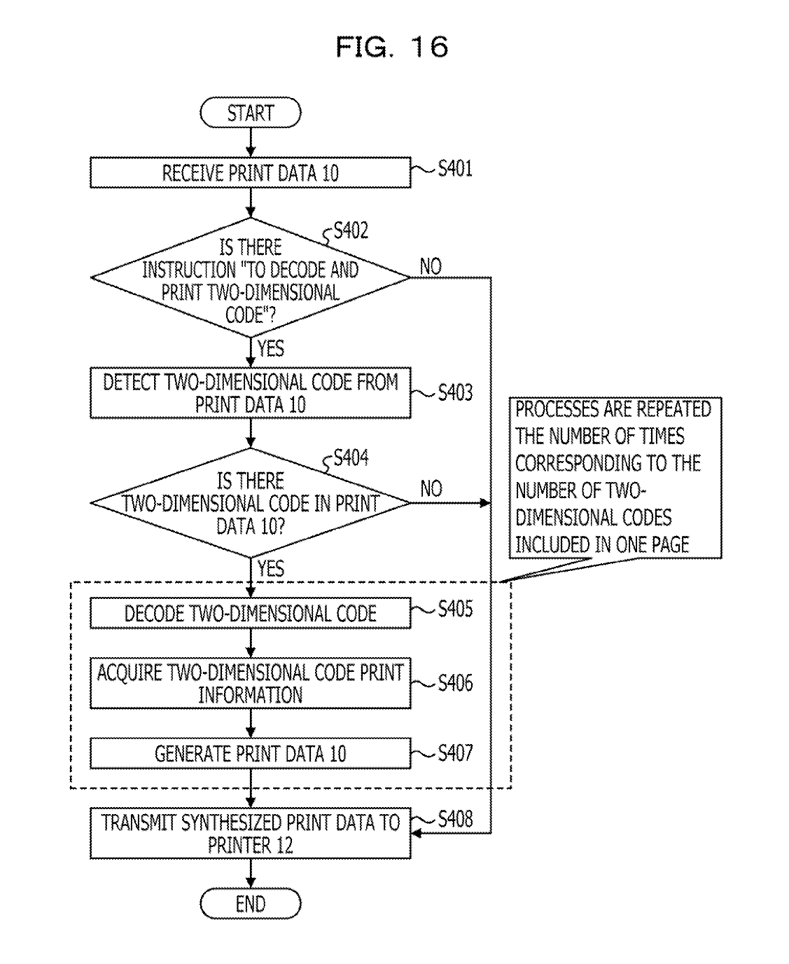

Next, printing processing of print data including a two-dimensional code will be described with reference to FIG. 16. FIG. 16 illustrates an example of a printing processing procedure of print data including a two-dimensional code.

The printer driver 2 receives the print data 10 (Operation S401). The printer driver 2 determines whether or not there is an instruction to decode and print two-dimensional code included in the print data 10 (Operation S402). If there is the instruction to decode and print two-dimensional code (YES in Operation S402), the printer driver 2 detects two-dimensional code from the print data 10 (Operation S403). The printer driver 2 determines whether or not there is a two-dimensional code in the print data 10 (Operation S404).

If there is a two-dimensional code in the print data 10 (YES in Operation S404), the printer driver 2 decodes the two-dimensional code (Operation S405). The two-dimensional code decoding library 56 is used to decode the two-dimensional code. The printer driver 2 acquires two-dimensional code print information (Operation S406). The two-dimensional code print information is a printing setting file, that is, an arrangement position and the like acquired from the two-dimensional code print information file 30.

The printer driver 2 generates the print data 10 by superimposing data obtained by decoding the two-dimensional code on the original image at the specified size and print position (Operation S407). In this case, for example, the processes of Operations S405, S406, and S407 are repeated the number of times corresponding to the number of two-dimensional codes included in one page of the print data 10. The printer driver 2 transmits the print data 10 to the printer 12 (Operation S408).

If there is not the instruction to decode and print two-dimensional code (NO in Operation S402), the printer driver 2 proceeds to Operation S408, transmits the print data 10 to the printer 12, and ends the processing.

If there is no two-dimensional code in the print data 10 in Operation S404, also, the printer driver 2 proceeds to Operation S408, transmits the print data 10 to the printer 12, and ends the processing.

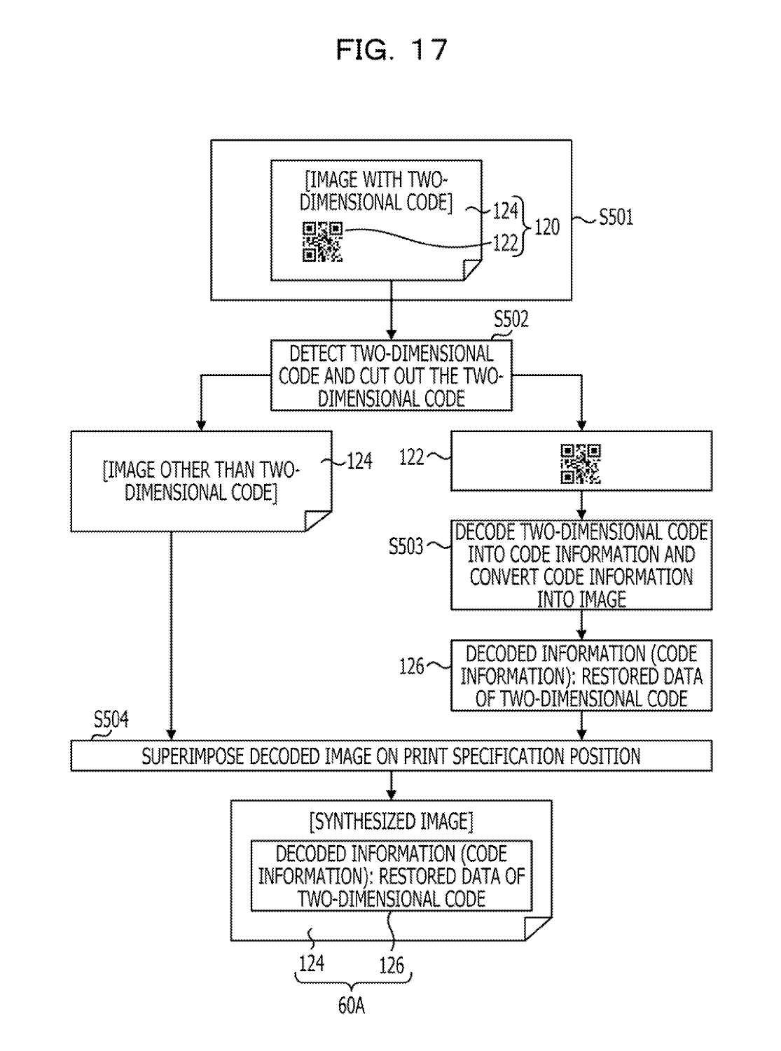

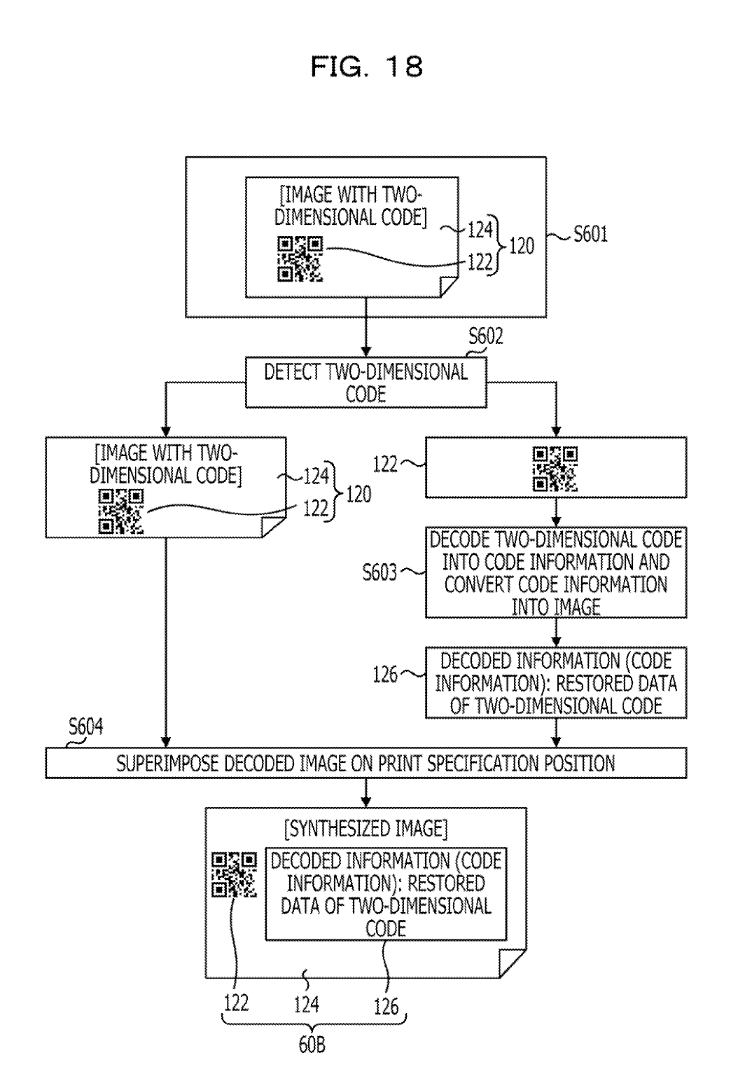

Synthesis and printing of an image with two-dimensional code will be described with reference to FIGS. 17 and 18. FIG. 17 illustrates an example of a processing procedure including processing for decoding and printing a two-dimensional code. FIG. 18 illustrates an example of a processing procedure including synthesis processing of two-dimensional code and decoded code information.

(1) Processing procedure of a case in which two-dimensional code decoding printing is set to ON and two-dimensional code image is not printed (FIG. 17).

The processing procedure is an example of processing performed by the printing method and the program disclosed in this description. The printer driver 2 acquires an image 120 with two-dimensional code (Operation S501). The image 120 with two-dimensional code is an example of the print data 10. The image 120 with two-dimensional code includes a two-dimensional code 122 and another image 124. The other image 124 is an image not including two-dimensional code 122.

The printer driver 2 detects the two-dimensional code 122 from the image 120 with two-dimensional code and cuts out the two-dimensional code 122 from the image 120 with two-dimensional code (Operation S502). As a result, the image 120 with two-dimensional code is divided into the two-dimensional code 122 and the other image 124. The printer driver 2 decodes the two-dimensional code 122 into code information and converts the code information into an image (Operation S503).

The printer driver 2 synthesizes the decoded information (code information) 126 and the other image 124 and superimposes them together (Operation S504), and, as a result, acquires a synthesized image 60A (Operation S505). The synthesized image 60A is an image in which the other image 124 without the two-dimensional code 122 and the decoded information 126 are synthesized together.

(2) Processing procedure of a case in which two-dimensional code decoding printing is set to ON and two-dimensional code image is printed (FIG. 18).

The processing procedure is an example of processing performed by the printing method and the program disclosed in this description. The printer driver 2 acquires an image 120 with two-dimensional code (Operation S601). The image 120 with two-dimensional code is an example of the print data 10. The image 120 with two-dimensional code includes a two-dimensional code 122 and another image 124. As described above, the other image 124 is an image not including two-dimensional code 122.

The printer driver 2 detects the two-dimensional code 122 from the image 120 with two-dimensional code (Operation S602), decodes the two-dimensional code 122 into code information, and converts the code information into an image (Operation S603).

The printer driver 2 synthesizes the decoded information (code information) 126 and the image 120 with two-dimensional code and superimposes them together (Operation S604), and, as a result, acquires a synthesized image 60B (synthesized image 60 in FIG. 5) (Operation S605). The synthesized image 60B is an image in which the image 120 with two-dimensional code and the decoded information 126 are synthesized together. In this case, the decoded information is arranged at an arrangement position acquired from the two-dimensional code print information file 30.

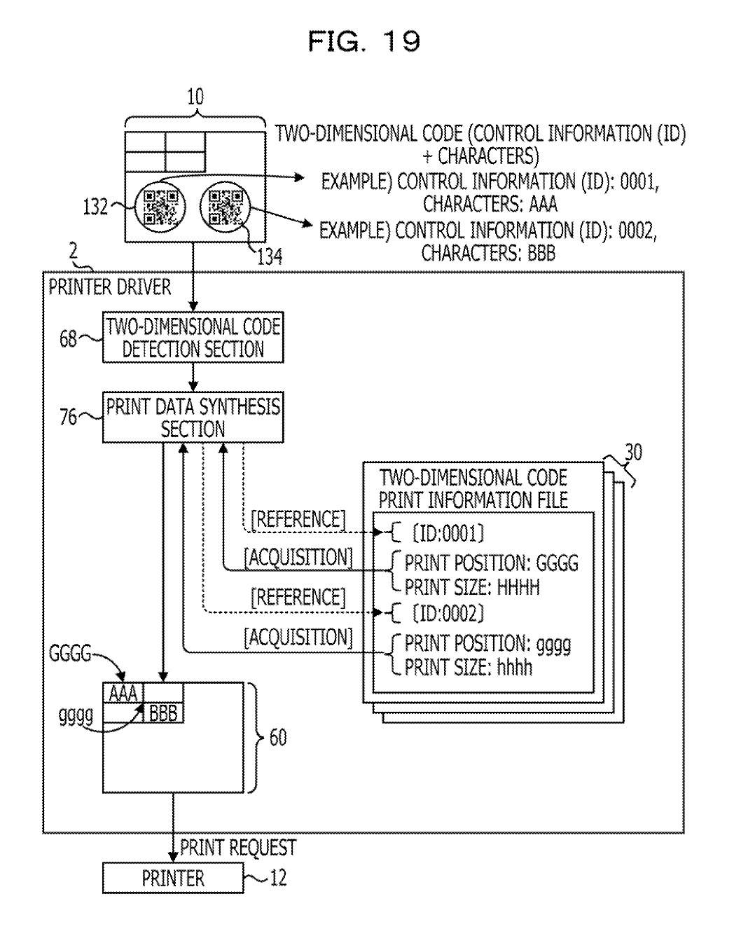

Next, information extraction from the two-dimensional code print information will be described with reference to FIG. 19. FIG. 19 illustrates an example of a processing procedure of the information extraction from the two-dimensional code print information.

In a two-dimensional code such as a QR code, control information is stored along with character data and image data. The control information is, for example, a character arrangement position ID indicating a character arrangement position. It is not necessary that one print data includes only one two-dimensional code. Even when one print data includes a plurality of two-dimensional codes, the printer driver 2 may analyze the plurality of two-dimensional codes.

The two-dimensional code stores character data and control information. The printer driver 2 which receives print data recognizes two-dimensional code included in the print data and decodes the two-dimensional code. The printer driver 2 acquires (reads) the character data and the control information by decoding the two-dimensional code and acquires a character arrangement position ID from the control information.

The two-dimensional code print information file 30 is prepared in advance. The character arrangement position ID and the arrangement position are registered in the two-dimensional code print information file 30. The printer driver 2 extracts arrangement position information corresponding to the acquired character arrangement position ID from the two-dimensional code print information file 30. The two-dimensional code print information file 30 may be prepared according to intended use. For example, if an arrangement position information file to be the two-dimensional code print information file 30 is prepared for each form data, it is possible to select a file according to form data to be printed and print the form data. In this case, if the character data is merged at the extracted arrangement position, a plurality of two-dimensional codes may be arranged and printed at specified positions.

The processing procedure (FIG. 19) is an example of processing performed by the printing method and the program disclosed in this description. The processing procedure includes the information extraction processing from the two-dimensional code print information.

As illustrated in FIG. 19, the print data 10 includes two two-dimensional codes 132 and 134. Each of the two-dimensional codes 132 and 134 includes control information (ID) and characters. For example, the two-dimensional code 132 has control information (ID) “0001” and characters “AAA”. For example, the two-dimensional code 134 has control information (ID) “0002” and characters “BBB”. The printing setting unit 10 is assumed to include form data.

The printer driver 2 detects the two-dimensional codes 132 and 134 from the print data 10 by the two-dimensional code detection section 68. The printer driver 2 decodes these two-dimensional codes 132 and 134 and acquires the control information (IDs) and the character information described above.

The decoded information is transferred to the print data synthesis section 76. The print data synthesis section 76 acquires print positions and sizes corresponding to the control information (IDs) from the two-dimensional code print information file 30 and acquires a font specified by the UI section 64.

The print data synthesis section 76 sets the decoded characters at the acquired print positions and merges the characters with the form data to generate a synthesized image 60. In the synthesized image 60, the characters “AAA” and “BBB” are set at the print positions corresponding to the control information (IDs). The synthesized image 60 is outputted from the printer driver 2 to the printer 12 as a print request.

The operations, characteristics, and effects of the present embodiment will be itemized below.

(1) The present embodiment includes a function for selecting a printing mode of two-dimensional code, and the options of the printing mode include “print two-dimensional code without decoding it”, “print decoded two-dimensional code by superimposing it on the original image” and “print decoded two-dimensional code as another image”.

(2) The present embodiment has a function capable of selecting and specifying printing setting such as a size, a print position, and the like when superimposing the decoded data (decoded information: code information) on an image.

(3) In the present embodiment, a user decides a printing mode of the two-dimensional code before starting printing. When “print two-dimensional code after decoding it” is selected, the present embodiment causes the user to select/specify the print position, the print size, whether or not to print the two-dimensional code on the original image, and the like.

(4) When “print two-dimensional code without decoding it” is selected, the present embodiment transmits print data including two-dimensional code to the printer and prints the two-dimensional code.

(5) When “print two-dimensional code after decoding it” is selected, the present embodiment detects a two-dimensional image from the print data 10. In this case, if two-dimensional code is not detected, the present embodiment prints the original data without change.

(6) If two-dimensional code is detected from the print data 10, the present embodiment decodes the two-dimensional code. The present embodiment generates an image of a specified image size from the decoded data and generates an image in which the image generated from the decoded data is superimposed on the print data at a specified position. That is to say, the present embodiment generates a synthesized image.

(7) There are modes described below for acquiring the print position and the size of two-dimensional code. In the first embodiment, the print position, the font of characters, and the like of the two-dimensional code specified on the UI section 64 are acquired. In the second embodiment, the two-dimensional code print information file is prepared in which the print position and the size of the two-dimensional code are specified. In this file, the print information IDs are prepared, and the print position and the size are specified for each ID. The print information ID is included in the two-dimensional code, and the present embodiment acquires the ID when analyzing the two-dimensional code. The print position, the size, and the like corresponding to the acquired print information ID may be acquired from the two-dimensional code print information file prepared in advance.

(8) The generated synthesized image is transmitted to the printer 12, and the printer 12 prints the synthesized image or the original image of the print data 10.

(9) When “do not print two-dimensional code” is selected, the present embodiment cuts out the portion of the two-dimensional code, generates a synthesized image by superimposing the decoded image on the cut-out image of the two-dimensional code, and prints the synthesized image.

(10) In this way, the printer driver 2 may specify the printing mode of an image including two-dimensional code.

(11) In the present embodiment, it is possible to select “print two-dimensional code after decoding it” or “print two-dimensional code without decoding it” when printing the two-dimensional code included in image data.

(12) The printer driver 2 has a function for decoding two-dimensional code and a function capable of setting the print position, the print size, and the like of decoded data. Thereby, the decoded data may be printed according to the setting.

(13) It is possible to select “print two-dimensional code without decoding it” or “print data of decoded two-dimensional code” for the two-dimensional code included in the print data, so a desired printout may be obtained.

(14) It is possible to set print position, print size, character font, and whether or not to print two-dimensional code by the UI section 64, and data of decoded two-dimensional code may be printed.

(15) It is possible to acquire the print information ID included in two-dimensional code, extract print information corresponding to the ID from the two-dimensional code print information file, reflect the print information in the printing setting, and print the data of decoded two-dimensional code.

(16) The printer driver 2 decodes and prints two-dimensional code. Thereby, the decoded information does not remain in the PC 22, so security function may be obtained.

(17) The print position and the print size of two-dimensional code may be specified. Thereby, the print position of decoded data may be specified or changed, and print data such as form data and two-dimensional code may be superimposed together to be printed, so that it is possible to perform printing with high general-purpose properties. The convenience of printing two-dimensional code is enhanced.

(18) The print position of two-dimensional code is not directly specified, so if the print position of the two-dimensional code is desired to be changed, it is not necessary to re-generate the two-dimensional code.

### Third Embodiment

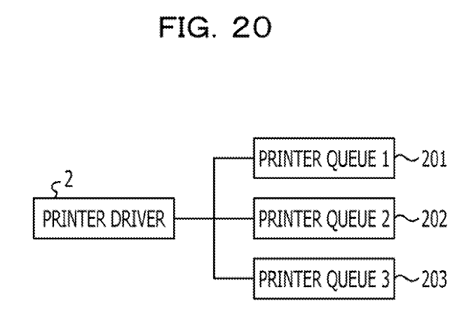

A third embodiment will be described with reference to FIG. 20. FIG. 20 illustrates an example of a setting of printer queues.

It is possible to generate a plurality of the same printers 12 connected from the printer driver 2 according to connection ports or intention of the user. The printer 12 is referred to as a printer queue. In the present embodiment, as illustrated in FIG. 20, for example, printer queues 201, 202, and 203 are set to a single printer driver 2 as a plurality of printer queues.

In such setting of printer queues, information such as a name of driver is stored in a registry of an application program such as Windows (registered trademark). This may be performed for each printer queue 201, 202, and 203. As a result, printing setting may be performed for each printer queue 201, 202, and 203, and printing using the setting may be performed.

The printer queues 201, 202, and 203 are generated by using the processes of “add printer” and “printer driver installation”.

In the printing using the printer queues 201, 202, and 203, printing is performed according to the settings set in the above-described setting screens of the printer queues 201, 202, and 203.

Therefore, the user may specify different printing settings for each printer queue 201, 202, and 203 in advance (for example, check specifications of the decoding specification checkboxes 92 and 94). When issuing a printing instruction, the user may specify a printer queue for which a desired printing setting is done among the printer queues 201, 202, and 203. In this way, the user may issue a printing instruction of QR code (two-dimensional code) in a desired printing setting without changing the printing setting of the printer driver 2 for each job. Thus, the present embodiment may improve user's operability.

### Fourth Embodiment

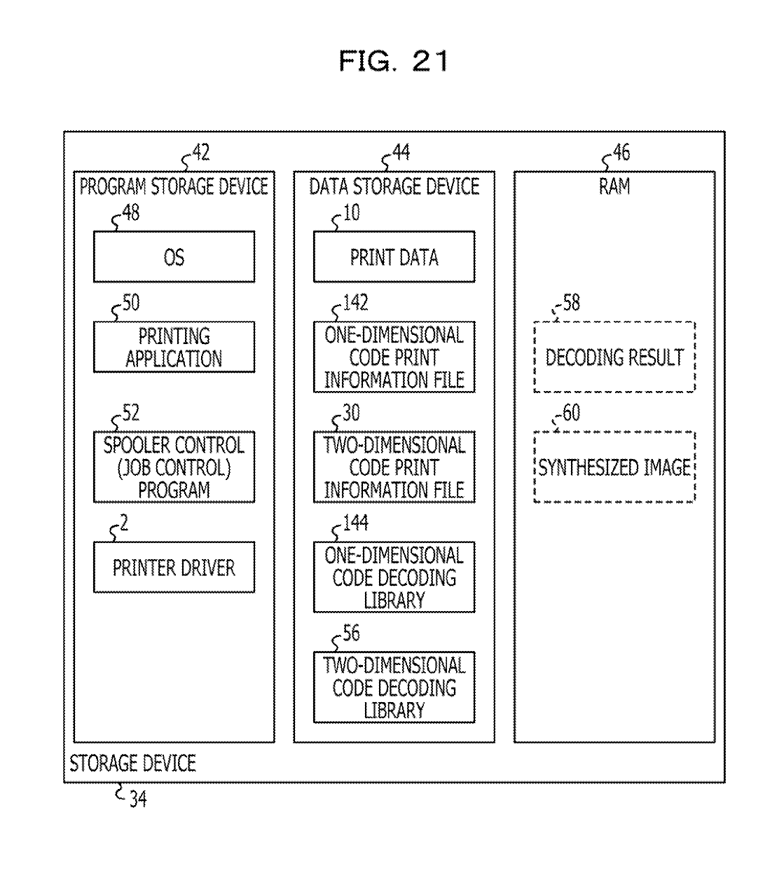

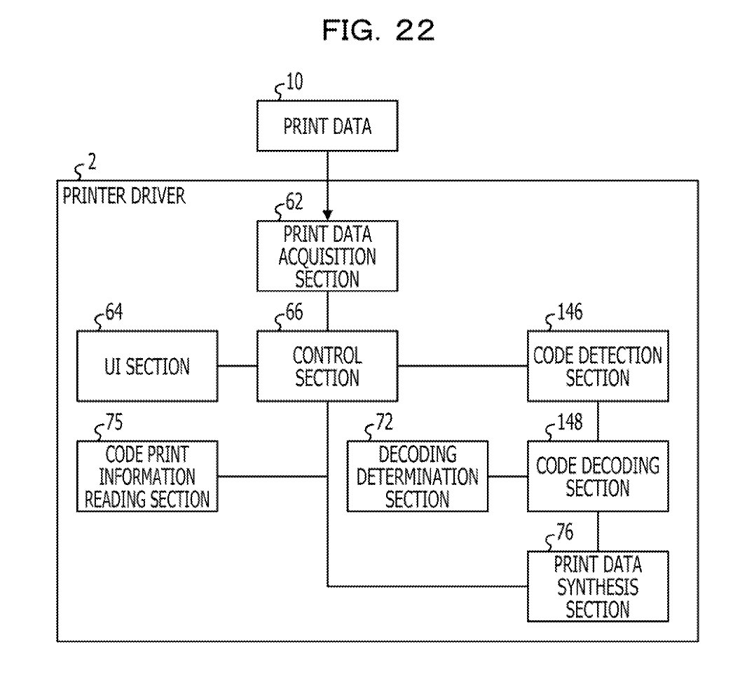

A fourth embodiment will be described with reference to FIGS. 21 and 22. FIG. 21 illustrates an example of a storage device. FIG. 22 illustrates an example of a printer driver. In FIGS. 21 and 22, the same portions as those in FIGS. 5 and 6 are given the same reference numerals.

Although, in the second embodiment, two-dimensional code is illustrated as an object to be decoded in the print data 10, the object to be decoded may be one-dimensional code or both the one-dimensional code and the two-dimensional code. In the present embodiment, the printer driver 2 may decode one-dimensional code. To decode one-dimensional code, as illustrated in FIG. 21, the data storage section 44 includes a one-dimensional code print information file 142 and a one-dimensional code decoding library 144.

As illustrated in FIG. 22, the printer driver 2 includes a code detection unit 146 for detecting both one-dimensional code and two-dimensional code and a code decoding unit 148 for decoding both one-dimensional code and two-dimensional code.

If such a configuration is employed, it is possible to perform decoding of one-dimensional code and two-dimensional code and synthesis printing of one-dimensional code or two-dimensional code by the printing processing including decoding processing performed by the printer driver 2 in the same manner as in the second embodiment.

Although, in the present embodiment, decoding processing of both one-dimensional code and two-dimensional code is described, only one-dimensional code may be processed.

### Fifth Embodiment

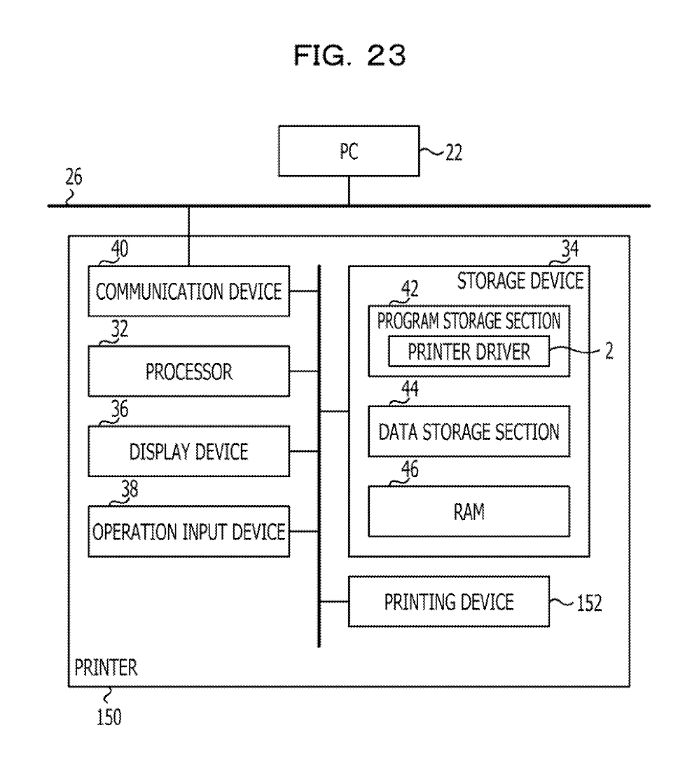

A fifth embodiment will be described with reference to FIG. 23. FIG. 23 illustrates an example of a printer according to the fifth embodiment. In FIG. 23, the same portions as those in FIGS. 5 and 6 are given the same reference numerals.

The printer 150 is an example of the printing apparatus disclosed in this description, an apparatus in which the printing method disclosed in this description is performed, and an apparatus in which the printing program disclosed in this description is running. The printer 150 includes functions and hardware provided in the PC 22 described above. In this case, the printer 150 includes a printing unit 152, which is a printing function unit. Assuming that the printer 150 has the configuration described above, when the print data 10 is provided from the PC 22, the printer 150 may decode the one-dimensional code or the two-dimensional code described above or both of them, and print the one-dimensional code or the two-dimensional code or both of them as a synthesized image along with another image.

### Other Embodiments

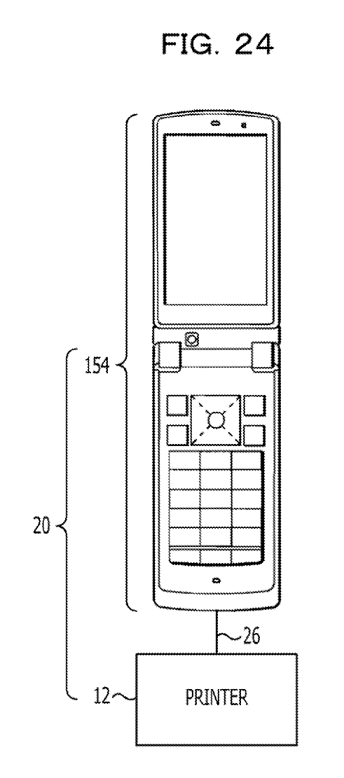

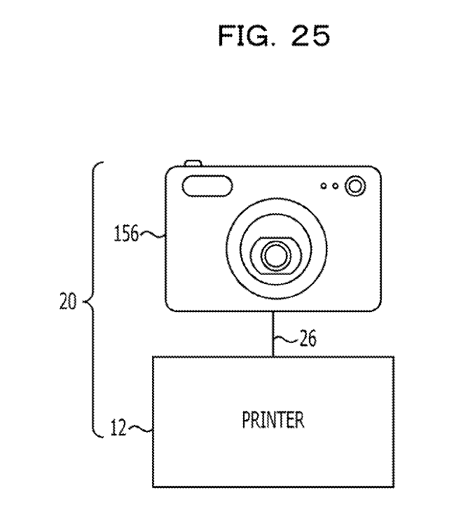

(1) Although, in the embodiments described above, the PC 22 is illustrated as the information processing apparatus disclosed in this description, the present invention is not limited to the PC 22. The information processing apparatus only has to include the printer driver 2 and a function to perform printing by the printer 12, and the information processing apparatus may be an electronic apparatus such as a mobile terminal apparatus 154 (FIG. 24) and a digital camera 156 (FIG. 25).

In the printing system 20 using the mobile terminal apparatus 154, as illustrated in FIG. 24, the printer driver 2 describe above is installed in the mobile terminal apparatus 154, and the mobile terminal apparatus 154 is connected with the printer 12 via the cable 26. The mobile terminal apparatus 154 may be a mobile phone or a personal digital assistant (PDA).

In the printing system 20 using the digital camera 156, as illustrated in FIG. 25, the printer driver 2 describe above is installed in the digital camera 156, and the digital camera 156 is connected with the printer 12 via the cable 26.

Even when employing such configurations, in the same manner as in the embodiments described above, it is possible to extract one-dimensional code and/or two-dimensional code from print data including one-dimensional code and/or two-dimensional code, decode the one-dimensional code and/or the two-dimensional code, synthesize the decoded information with other information to print the decoded information with the other information, and delete the decoded information after printing the decoded information. It is possible to obtain the same effects as those of the above embodiments.

(2) Although the storage device 34 is illustrated as the recording medium that may be read by a computer, other recording media such as a cache memory and a DVD may be used in addition to the HDD as the storage device 34.

### Comparative Example

When the original data of the two-dimensional code is printed, the two-dimensional code is decoded by a conversion tool or the like to obtain the original data, the original data is converted into an image, and then the image is printed. Concerning security, it is not preferable if the decoded data remains on the PC. When an image including two-dimensional code is printed, the two-dimensional code is decoded, the decoded data is converted into an image, and the converted image is superimposed on the original image to be printed. When the superimposed printing is performed, if the print position of the two-dimensional code cannot be specified, general-purpose property is lost. Such a problem is solved by the embodiments described above.

Next, with respect to the above-described embodiments, the following appendices are further disclosed. The present invention is not limited to the following appendices.

Although the most preferred embodiments of the printing method, the program, the information processing apparatus, and the printing apparatus have been described, the present invention is not limited to the above description, but various changes and modifications are of course possible by those skilled in the art on the basis of the gist of the invention described in the claims or disclosed in the modes for carrying out the invention, and, needless to say, such changes and modifications are included in the scope of the invention.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A printing method of print data performed by an apparatus, the method comprising:
providing a first printing mode in which printing including decoding is performed and a second printing mode in which printing without decoding is performed to an output apparatus as options;
generating code information by decoding coded information included in the print data when the first printing mode is selected;
storing the code information into a storage device;
generating a synthesized image based on the code information and the print data; and
deleting the code information in the storage device after printing the synthesized image.

2. The printing method according to claim 1, further comprising:
providing selection information including one of a print position selection, a print size, a character font, and a coded information printing to the output apparatus,
wherein when generating the synthesized image, the synthesized image is generated according to content specified from the selection information.

3. The printing method according to claim 1, further comprising:
acquiring control information included in the coded information; and
reading print information corresponding to the control information from a file and reflecting the print information in a printing setting when performing the printing.

4. A non-transitory computer-readable recording medium storing a program executed by a computer is recorded, the program causing a computer to perform a method, the method comprising:
providing a first printing mode in which printing including decoding is performed and a second printing mode in which printing without decoding is performed to an output apparatus as options;
generating code information by decoding coded information included in print data when the first printing mode is selected;
storing the code information into a storage device;
generating a synthesized image based on the code information and the print data; and
deleting the code information in the storage device after printing the synthesized image.

5. The recording medium according to claim 4, the method further comprising:
providing selection information including one of a print position selection, a print size, a character font, and a coded information printing to the output apparatus,
wherein when generating the synthesized image, the synthesized image is generated according to content specified from the selection information.

6. The recording medium according to claim 4, the method further comprising:
acquiring control information included in the coded information; and
reading print information corresponding to the control information from a file and reflecting the print information in a printing setting when performing the printing.

7. An information processing apparatus for processing print data, the apparatus comprising:
a printing mode selection unit that provides a first printing mode in which printing including decoding is performed and a second printing mode in which printing without decoding is performed to an output apparatus as options, and causing a user to select one of the options;
a code information restoration unit that generates code information by decoding coded information included in the print data when the first print mode is selected;
a storage device that stores the code information; and
a data processing unit that generates a synthesized image based on the code information in the storage device and the print data and deleting the code information after printing the synthesized image.

8. The information processing apparatus according to claim 7, further comprising:
a providing unit that provides selection information including one of a print position selection, a print size, a character font, and a coded information printing to the output apparatus,
wherein the data processing unit generates the synthesized image according to content specified from the selection information.

9. The information processing apparatus according to claim 7, further comprising:
an acquisition unit that acquires control information included in the coded information; and
a processing unit that reads print information corresponding to the control information from a file and reflecting the print information in a printing setting when performing the printing.
